(19) United States
(12) Patent Application Publication
(10) Pub. No.: US 2013/0038102 A1
(43) Pub. Date: Feb. 14, 2013

(54) Vehicle Seat System

(71) Applicants: Sven Friderich, Boeblingen (DE); Gudrun Schoenherr, Karlsruhe (DE)

(72) Inventors: Sven Friderich, Boeblingen (DE); Gudrun Schoenherr, Karlsruhe (DE)

(73) Assignee: Daimler AG, Stuttgart (DE)

(21) Appl. No.: 13/577,087

(22) PCT Filed: Dec. 23, 2010
(86) PCT No.: PCT/EP2010/007938

§ 371 Date: Oct. 26, 2012

(30) Foreign Application Priority Data
Feb. 5, 2010 (DE) 10 2010 007 203.6

(51) Int. Cl. B60N 2/44

(52) U.S. Cl. 297/217.4; 297/217.1

(57) ABSTRACT

An opportunity for stimulating an occupant of a vehicle seat in order to activate his/her body and mind is provided. For this purpose, a vehicle seat system includes a vehicle seat with a massage device for influencing the seat contour integrated into the seat back and a control unit for controlling the massage device. The system also includes a communication device that can transmit at least one instruction to an occupant of the vehicle seat in response to the control of the massage device.

### BACKGROUND AND SUMMARY OF THE INVENTION

The invention relates to a vehicle seat system and a method for physically activating an occupant sitting on a vehicle seat of a vehicle seat system of this type.

German Patent Document No. DE 10 2009 008 421 A1 discloses a vehicle seat with a massage device integrated into its seat back, which massage device comprises a plurality of elements to which pressure can be applied and which can be selected by means of a control unit to influence the seat contour, allowing different sequences or massage programs to be implemented. An occupant of the vehicle seat remains passive and lets the massage do its work, improving his/her wellbeing. With increasing journey time and in particular in a traffic jam or on a boring stretch of road, the body tires and attention is reduced.

Exemplary embodiments of the present invention provide the occupant of a vehicle seat with an opportunity for stimulation for the activation of his/her body.

In accordance with exemplary embodiments of the present invention, a vehicle seat system comprises a vehicle seat with a massage device for influencing the seat contour integrated into the seat back and further comprising a control unit for controlling the massage device. The vehicle seat system further comprises a communication device by means of which at least one instruction can be transmitted to the occupant of the vehicle seat in response to the control of the massage device.

In other words, a vehicle seat system with a vehicle seat comprising a controlled massage device and with a communication device is provided, by means of which communication device an instruction can be given to an occupant while a massage program of the massage device is running. This can stimulate the occupant into activity during the massage, so that he/she can, for example, make his/her body act intentionally in accordance with a desired massage effect; this can also activate the mind.

In an advantageous further development of the invention, a visual and/or audible instruction can be given to the occupant of the vehicle seat by means of the communication device. In a further development of the invention, it has been found to be particularly useful if the visual instruction is received in text form and/or the audible instruction is a verbal announcement, so that a clear and distinct instruction can be transmitted to the occupant.

In a further variant of the invention, it has further been found to be advantageous if the instruction of the communication device is an instruction relating to the posture, bodily tension, breathing, bodily movement and/or reaction of the occupant to an action of the massage device. In this way, for example, the coordination and stabilization of the trunk muscles of the occupant can be activated and improved, for example by instructing the occupant to deliberately activate different sections of the upper body. The reaction of the occupant may, for example, be a pressing against at least a section of the seat back if the occupant feels a pressure of the massage device in the back.

The advantages explained above in the context of the vehicle seat system according to the invention apply likewise to the method according to the invention for the bodily activation of an occupant.

### BRIEF DESCRIPTION OF THE DRAWING FIGURES

Further advantages, features and details of the invention can be derived from the following description of a preferred embodiment and from the drawing. Of the drawing:

FIG. 1 is a side view of an occupant of a car, showing his spinal cord, the occupant sitting on a vehicle seat with a rounded spinal cord; and

FIG. 2 is a side view of the occupant from FIG. 1, in which the occupant has changed his sitting position and follows the instructions of a running massage program.

### DETAILED DESCRIPTION

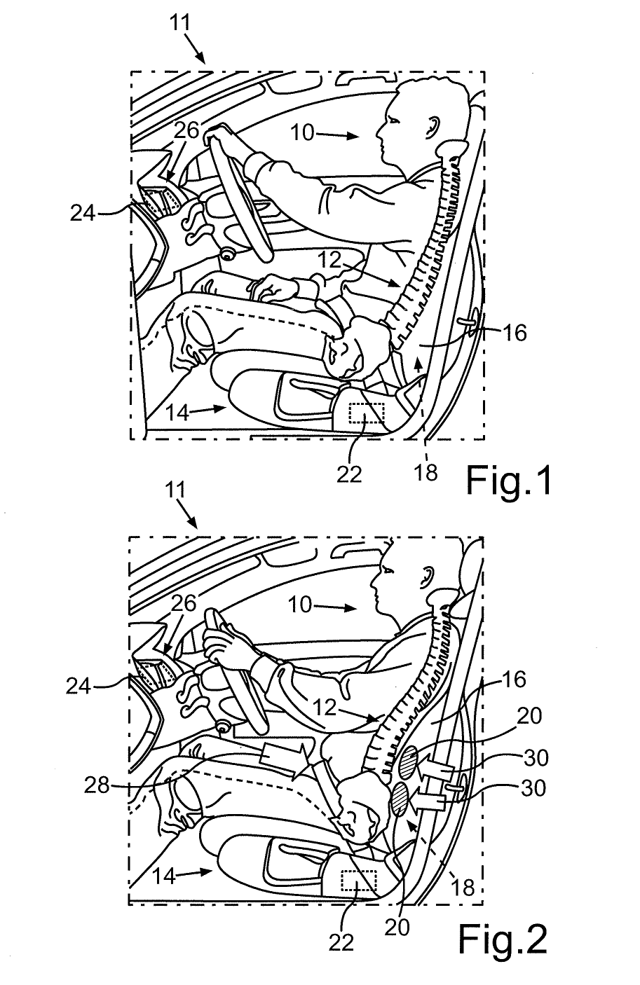

FIGS. 1 and 2 are side views of an occupant 10 of a car 11, sitting on a driver-side vehicle seat 14; the figure shows his spinal column 12.

After prolonged sitting during long-distance journeys, the bodies and minds of the occupants tire even if the seats are ergonomically optimized. This can result in changes to the posture of the spinal cord 12, which initially is optimally upright, leading to faulty postures.

FIG. 1 shows that the spinal cord 12 of the occupant 10 has a rounded posture, in which the thoracic spine 12 is bent backwards more strongly (increased thoracic kyphosis) while the pelvis it tilted towards the rear, thereby reducing the hollowness of the lumbar spine (reducing the physiological backward curvature of the lumbar spine). If the spinal cord 12 is rounded, the intervertebral discs are unevenly loaded, leading to a displacement of the disc core and to a straining of the back muscles, both of which are undesirable.

To change this, the car is provided with a vehicle seat system in which the vehicle seat 14 has a seat back 16 into which a massage device 18 is integrated to influence the seat contour. FIG. 2 diagrammatically illustrates two elements 20 of a plurality of elements 20 of the massage device 18; these are pneumatically inflated to influence the seat contour, for example by applying pressure. Such elements 20 can be arranged symmetrically to the left, to the right and along a central line of the seat back 16. The massage device 18 is controlled in the execution of massage programs by a control unit 22 indicated only diagrammatically in the drawing.

The vehicle seat system further comprises a communication device 24 indicated only diagrammatically in the drawing, by means of which instructions can be transmitted to an occupant of the vehicle seat in response to the control of the massage device and while a massage program runs in the vehicle seat. The communication device 24 comprises a display 26 on which the instructions appear in text form. The communication device 24 and/or the display 26 may for example be a part of an infotainment system.

In addition to or as an alternative to the communication device 24 with its display 26, by means of which the instructions are transmitted visually, an audible instruction, for example in the form of a verbal announcement, is conceivable as well.

The occupant 10 is instructed to become active during the massage, so that he/she consciously acts with his/her body in accordance with a desired effect of the massage; as a result, he/she becomes mentally active as well.

FIG. 2 is a side view of the occupant 10 from FIG. 1, in which the occupant 10, instructed by the communication device 24, has changed his seated posture and follows the further instructions of a running massage program. The instructions may relate to the posture of the occupant, to bodily tension, breathing, bodily movement and a reaction of the occupant 10 to an action of the massage device. Such a reaction of the occupant 10 may be, for example, as indicated by the arrow 28 in FIG. 2, a pressing against at least a section of the seat back 16 if the occupants feels a pressure from the two lower elements 20 of the massage device 18 in the back, as indicated by the arrows 30 in FIG. 2.

Such instructions may be, for example ,as follows:
Sit upright and lean against the seat back.
Remain upright even while exercising.
As soon as you feel a pressure against your back, apply a counterpressure at this point.
If pressure is applied to the lower back, tension your stomach muscles and push your lower back towards the rear for 4 seconds. Please do not push with feet and legs. Remain upright, keeping your upper body straight.
If pressure is applied to the upper back, apply a counterpressure precisely at this point. Do the same if pressure is applied to other points.
Keep breathing. Alternatively breathe at each tightening and at each application of counterpressure.
As soon as you feel a pressure against your lower back, twist your pelvis towards the rear.
Pressure under the feet remains constant! Do not brace yourself against the pedals.
You feel the tensioning of your stomach muscles.
The upper body remains straight.
Breathing continues.

In the course of the massage program, various sections of the upper body can be selected and activated in this way. It is evident that this encouragement of the occupant towards active participation results in a coordination and stabilization of the trunk muscles. In contrast to the massage with its passive effect on the occupant, this function stimulates both body and mind.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-5. (canceled)

6. A vehicle seat system comprising:
a vehicle seat with a seat back, wherein a massage device configured to influence a seat contour is integrated into the seat back;
a control unit configured to control the massage device; and
a communication device configured to transmit at least one instruction to an occupant of the vehicle seat in response to the control of the massage device.

7. The vehicle seat system according to claim 6, wherein the communication device is configured to transmit a visual or audible instruction to the occupant of the vehicle seat as the at least one instruction.

8. The vehicle seat system according to claim 7, wherein the visual instruction is in text form or the audible instruction is a verbal announcement.

9. The vehicle seat system according to claim 6, wherein the at least one instruction of the communication device relates to posture of the occupant, to bodily tension, breathing, bodily movement or a reaction of the occupant to an action of the massage device.

10. A method for the activation of an occupant sitting on a vehicle seat of a vehicle seat system with a massage device for influencing a seat contour integrated into a seat back of the vehicle seat, the method comprising:
massaging the occupant of the vehicle seat by controlling the massage device using a control unit of the vehicle seat system; and
transmitting at least one instruction is transmitted to the occupant of the vehicle seat in response to the control of the massage device.
